(19) United States
(12) Patent Application Publication
(10) Pub. No.: US 2024/0411053 A1
(43) Pub. Date: Dec. 12, 2024

(54) ATHERMAL METALENS AND DESIGN METHOD

(71) Applicant: SHENZHEN METALENX TECHNOLOGY CO., LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO., LTD, Shenzhen (CN)

(21) Appl. No.: 18/810,499

(22) Filed: Aug. 20, 2024

Related U.S. Application Data
(63) Continuation of application No. PCT/CN2022/143174, filed on Dec. 29, 2022.

(30) Foreign Application Priority Data
Feb. 23, 2022 (CN) 202210170121.5

(51) Int. Cl. G02B 1/00; G02B 3/08; G02B 27/00

(52) U.S. Cl. CPC G02B 1/002; G02B 3/08; G02B 27/0012; G02B 2207/101

(57) ABSTRACT

Provided is an athermal metalens, the metalens includes: a substrate and a plurality of nanostructures; the plurality of nanostructures are set on at least one side of the substrate, and are arranged in a periodicity; where a thermal refractive index coefficient of the plurality of nanostructures is less than a reference thermal refractive index coefficient; or each nanostructure is composed of at least two materials, and the product of the thermal refractive index coefficient of the at least two materials is less than 0. Thus, the effective refractive index of the nanostructures is insensitive to the temperature changes, and the reduced imaging performance of the metalens caused by temperature drift is improved.

### CROSS-REFERENCE TO RELATED APPLICATION

This disclosure is a continuation of International Patent disclosure of PCT disclosure serial PCT/CN2022/143174, filed on Dec. 29, 2022, which claims the benefit of priority from Chinese disclosure No. 202210170121.5, filed on Feb. 23, 2022. The content of the aforementioned disclosures, including any intervening amendments thereto, are incorporated herein by reference.

### TECHNICAL FIELD

The present disclosure relates to the field of optical technology field, in particular to an athermal metalens and a design method.

### BACKGROUND

Generally, the optical system is only designed for a sole environment temperature of 20° C. However, when the optical system is used in a larger temperature range, the thermal expansion and cold contraction of the lens barrel material, the lens material and the thermal refractive index coefficient of the optical material will change the focal power of the lens and cause a defocus phenomenon, leading to the deterioration of the imaging quality. This phenomenon is also called temperature drift. The lens that can overcome the influences of temperature drift are known as athermal lens.

And the temperature drift of traditional lenses is solved by the cooperation of optical materials with different thermal refractive index coefficients. Unlike conventional lenses, metalens is a specific application of metasurface technology. Metalens is an artificial layered structure of sub-wavelength thickness that regulates the frequency, amplitude and phase of incident light through the nanostructures arranged in an array. There is no solution to solve the problem of temperature drift for metalens in the prior art, that is to say, the design of athermal metalens in the existing technology is still blank.

Therefore, with the industrialization of the metalens, an athermal metalens is urgently needed to improve the deterioration of metalens imaging performance caused by temperature drift.

### SUMMARY

In view of the above technical problems, an athermal metalens and a design method are provided according to embodiments of the present disclosure, so as to overcome the problems in the prior art.

In the first aspect, an athermal metalens is provided, the metalens includes: a substrate and a plurality of nanostructures; the plurality of nanostructures are set on at least one side of the substrate, and are arranged in a periodicity; where a thermal refractive index coefficient of the plurality of nanostructures is less than a reference thermal refractive index coefficient.

In one embodiment, the metalens includes: the reference thermal refractive index coefficient is greater than or equal to 0.01×10⁻⁶/K, and is less than or equal to 3000×10⁻⁶/K.

In one embodiment, the metalens includes: a filler material, and the filler material is used to fill the gaps between the plurality of nanostructures.

In one embodiment, the metalens includes: the extinction coefficient of the substrate is less than 10⁻⁴.

In the second aspect, an athermal metalens is provided and the athermal metalens includes: a substrate and a plurality of nanostructures; the plurality of nanostructures are set on one side of the substrate at least and arranged in periodicity; where each nanostructure is composed of at least two materials, and the product of the thermal refractive index coefficient of the at least two materials is less than 0.

In one embodiment, the reference thermal refractive index coefficient is greater than or equal to 0.01×10⁻⁶/K, and is less than or equal to 3000×10⁻⁶/K.

In one embodiment, when the nanostructure is composed of at least two materials, the nanostructure is made of two different materials along the direction of the height axis.

In one embodiment, when the nanostructure is composed of at least two materials, the nanostructure is made of two different materials along the direction perpendicular to the height axis.

In one embodiment, the plurality of nanostructures are arranged in a plurality of unit cells; the plurality of nanostructures are dense-packed pattern to form the unit cell, and the vertice or center of the dense-packed pattern is set with the nanostructure.

In one embodiment, the extinction coefficient of the nanostructure is less than 10⁻².

In one embodiment, a filler material, and the filler material is used to fill the gaps between the nanostructures.

In the third aspect, a design method for an athermal metalens is provided, S1. determining a system parameter of the athermal metalens;
S2. selecting a material according to the system parameter, and the thermal refractive index coefficient of the material is less than the reference thermal refractive index coefficient;
S3. performing a temperature drift analysis to the nanostructures;
S4. if the results of the temperature drift analysis don't meet the design requirement, repeating the S2 to S3 until the results of the temperature drift analysis of the nanostructure meet the design requirement.

In one embodiment, the S3 includes:
S301. according to the thermal refractive index coefficient, calculating the refractive index of the plurality of nanostructures, the refractive index of the filler material and the refractive index of the substrate at different temperatures;
S302. according to the refractive index of the plurality of nanostructures, the refractive index of the filler material and the refractive index of the substrate, calculating the effective refractive index of the athermal metalens;
S303. according to the effective refractive index of the athermal metalens and the height of the plurality of nanostructures, calculating the phase response of the athermal metalens;
S304. according to the phase response of the athermal metalens at different temperatures, calculating the focus offset of the athermal metalens.

In one embodiment, the S3 includes:
S301. according to the thermal refractive index coefficient, calculating the refractive index of the plurality of nanostructures, the refractive index of the filler material and the refractive index of the substrate at different temperatures;
S302′. according to the refractive index of the nanostructures, the refractive index of the filler material and the refractive index of the substrate, obtaining the phase response of the athermal metalens by the numerical analysis simulation;
S304. according to the phase response of the athermal metalens at different temperatures, calculating the focus offset of the athermal metalens.

In one embodiment, a design method for an athermal metalens is provided, the method includes:
S1. determining a system parameter of the athermal metalens;
S2. selecting at least two materials according to the system parameter, and the product of the thermal refractive index coefficient of the at least two materials is less than 0;
S3. performing a temperature drift analysis to the plurality of nanostructures;
S4. if the results of the temperature drift analysis don't meet the design requirement, repeating the S2 to S3 until the results of the temperature drift analysis of the plurality of nanostructure meet the design requirement.

In one embodiment, the S2 includes:
S201. calculating the effective refractive index of the plurality of nanostructures at different temperatures;
S202. according to the following formulas, calculating the height or thickness of the plurality of nanostructures;

$$\{ \begin{matrix}{h}_{1} \frac{{dn}_{1}}{dT} + {h}_{2} \frac{{dn}_{2}}{dT} + … + {h}_{i} \frac{{dn}_{i}}{dT} = 0 \\ H = \sum {h}_{i}\end{matrix} ; or$$

$$\{ \begin{matrix}{d}_{1} \frac{{dn}_{1}}{dT} + {d}_{2} \frac{{dn}_{2}}{dT} + … + {d}_{i} \frac{{dn}_{i}}{dT} = 0 \\ D = \sum {d}_{i}\end{matrix} ;$$

Where dnᵢ/dT is the thermal refractive index coefficient of each material in the nanostructure, hi is the height of each material in the nanostructure; H is the height of the nanostructure; di is thickness of each material along the direction perpendicular to the height axis; D is the total thickness of each material in the nanostructure.

In one embodiment, the S3 includes:
S301. according to the thermal refractive index coefficient, calculating the refractive index of the plurality of nanostructures, the refractive index of the filler material and the refractive index of the substrate at different temperatures;
S302. according to the refractive index of the plurality of nanostructures, the refractive index of the filler material and the refractive index of the substrate, calculating the effective refractive index of the athermal metalens;
S303. according to the effective refractive index of the athermal metalens and the height of the plurality of nanostructures, calculating the phase response of the athermal metalens;
S304. according to the phase response of the athermal metalens at different temperatures, calculating the focus offset of the athermal metalens.

In one embodiment, the S3 includes:
S301. according to the thermal refractive index coefficient, calculating the refractive index of the plurality of nanostructures, the refractive index of the filler material and the refractive index of the substrate at different temperatures;
S302′. according to the refractive index of the plurality of nanostructures, the refractive index of the filler material and the refractive index of the substrate, obtaining the phase response of the athermal metalens by the numerical analysis simulation;
S304. according to the phase response of the athermal metalens at different temperatures, calculating the focus offset of the athermal metalens.

The present disclosure has at least the following beneficial effects:

According to the athermal metalens and design method provided by the present disclosure, the thermal refractive index coefficient of the nanostructures is less than a reference thermal refractive index coefficient. Or the nanostructure is composed of at least two materials, and the product of the thermal refractive index coefficient of the at least two materials is less than 0. Thus, the effective refractive index of the nanostructures is insensitive to the temperature changes, and the reduced imaging performance of the metalens caused by temperature drift is improved.

### BRIEF DESCRIPTION OF THE DRAWINGS

In order to explain more clearly, the technical scheme in the disclosure technology or the background technology, the attached drawings required in the disclosure embodiment or the background technology will be explained below.

FIG. 1 shows an optional diagram of the athermal metalens provided by the embodiment of the present application.

FIG. 2 shows another optional diagram of the athermal metalens provided by the embodiment of the present application.

FIG. 3 shows an optional diagram of the nanostructure arrangement of the athermal metalens provided by the embodiment of the present application.

FIG. 4 shows another optional diagram of the nanostructure arrangement of the athermal metalens provided by the embodiment of the present application.

FIG. 5 shows another optional diagram of the nanostructure arrangement of the athermal metalens provided by the embodiment of the present application.

FIG. 6 shows an optional schematic diagram of the nanostructure provided by the embodiment of the present application.

FIG. 7 shows another optional schematic diagram of the nanostructure provided by the embodiment of the present application.

FIG. 8 shows an optional schematic diagram of the design method for the athermal metalens.

FIG. 9 shows another optional schematic diagram of the design method for the athermal metalens.

FIG. 10 shows another optional schematic diagram of the design method for the athermal metalens.

FIG. 11 shows another optional schematic diagram of the design method for the athermal metalens.

FIG. 12 shows the phase variations at different temperatures of an optional athermal metalens.

FIG. 13 shows the phase variations at different temperatures of another optional athermal metalens.

### DETAILED DESCRIPTION OF DISCLOSURED EMBODIMENTS

To facilitate the understanding of this application, a more comprehensive description of this application will be given with reference to the accompanying drawings. A preferred embodiment of this application is given in the accompanying drawings. However, the present application may be implemented in many different forms and is not limited to the embodiments described herein. Conversely, the purpose of providing these embodiments is to provide a more thorough understanding of the disclosure content of the present application.

It should be noted that when one element is considered to “connect” another element, it can be directly connected to and combined with another element, or a central element may exist at the same time. The terms “installation”, “one end”, “the other end” and similar expressions used in this article are intended for illustrative purposes only.

Unless other have defined, all technical and scientific terms used herein have the same meaning as generally understood by technicians in the technical field of this application. The terms used in the specification of this application are only for the purpose of describing specific embodiments and are not intended to restrict this application. The term “and/or” used in this article includes any and all combinations of one or more related listed items.

For traditional lenses, due to the change of temperature, the shape of surface of the traditional lens changes due to thermal expansion and cold contraction, which will lead to the defocus of the traditional lens, thus reducing the imaging quality. The shape of surface of the optical lens will change due to the influenced caused by the axial temperature gradient. The axial temperature gradient refers to the temperature difference between the two surfaces of the optical lens. For traditional lenses, it is generally believed that the shape of surface of the traditional lens will not cause temperature drift when the axial temperature gradient of the traditional lens is less than 4° C.

For metalenses, the axial temperature gradient is much less than 4° C. because the metalens thickness is much smaller than that of traditional lenses. Therefore, it is generally accepted that the defocus caused by the change of the shape of surface will be insufficient to reduce the imaging quality. Thus there is also a technical bias that the metalens has no need for the athermal design.

However, when the metalens is at a large temperature range (e.g. −20° C.˜100° C.), the temperature drift of the metalens will influence the imaging quality. In particular, when the metalens is used in precision instruments, the influence of temperature drift on the imaging quality is more significant. For example, when the metalens is combined with the laser technology, the axial temperature gradient of the metalens increases significantly under the laser irradiation because the power of the lasers is much higher than that of the ordinary beams, and the temperature drift phenomenon is more obvious.

In addition, the metalens modulates the incident light by the nanostructures. However, temperature changes can adversely influence the optical performance of nanostructures, thus reducing the quality of the imaging performance of the metalens.

Therefore, an athermal metalens is urgently needed to overcome the influence of temperature drift on the imaging quality.

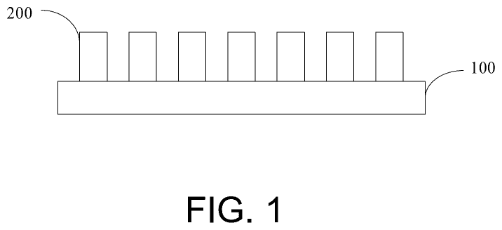

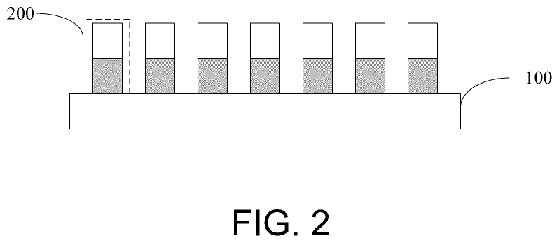

An athermal metalens is provided, as shown in FIG. 1 and FIG. 2, the metalens includes: a substrate and a plurality of nanostructures; the plurality of nanostructures are set on at least one side of the substrate, and are arranged in a periodicity; where a thermal refractive index coefficient of the plurality of nanostructures is less than a reference thermal refractive index coefficient, or each nanostructure is composed of at least two materials, and the product of the thermal refractive index coefficient of the at least two materials is less than 0.

It should be noted that the thermal refractive index coefficient (dn/dT) refers to the changes of the refractive index caused within the temperature unit. The reference thermal refractive index coefficient is determined by the working temperature range of the athermal metalens. Optionally, the reference thermal refractive index coefficient is greater than or equal to 0.01×10⁻⁶/K, and is less than or equal to 3000×10⁻⁶/K.

Because the metalens modulates the incident light by the nanostructures, and the temperature change will influence the optical performance of the nanostructure. Therefore, the athermal metalens provided by the embodiment of this disclosure reduces the influence of the optical performance caused by the temperature changes by modulating the thermal refractive index coefficient of the nanostructures 200.

Specifically, in the athermal metalens provided in the present application, as shown in FIG. 1, the nanostructure 200 is composed of a single material. Preferably, the nanostructure 200 is composed of a material with a thermal refractive index coefficient of the plurality of nanostructures is less than a reference thermal refractive index coefficient. More specifically, the phase variations of the nanostructure 200 made of one material change less than the reference value. For example, the phase variations of the nanostructure 200 made of one material changes by less than 5% with temperature. When the nanostructure 200 made of one material still fails to satisfy the design requirement of the athermal metalens at a large range of temperatures. As shown in FIG. 2, the nanostructures 200 may be composed by two materials or more than two materials. In the nanostructures 200, each nanostructure is composed of at least two materials, and the product of the thermal refractive index coefficient of the at least two materials is less than 0. By regulating the thermal refractive index coefficient of the nanostructure 200, the effective refractive index of the nanostructure 200 is insensitive to the temperature.

Further, for the nanostructures 200 composed of at least two materials, the two materials are different along the height axis of the nanostructure. For example, the nanostructure 200 is composed of two different materials. It should be understood that for the nanostructure 200 composed of at least two materials, the material is different along the direction perpendicular to the height axis of the nanostructure. For example, if the nanostructure 200 is a cylindrical, the material is different along the diameter direction. It should be noted that the above “different” means that the nanostructures 200 is composed of at least two materials along the specified direction. More preferably, for the nanostructure 200 composed of at least two materials, the absolute value of the overall thermal refractive index coefficient is less than the reference thermal refractive index coefficient.

Furthermore, the substrate 100 and the nanostructure 200 provided by the embodiment of the present application have a high transmittance in the working waveband. Optionally, the extinction coefficient of the plurality of nanostructures is less than 10⁻². The extinction coefficient of the substrate is less than 10⁻⁴.

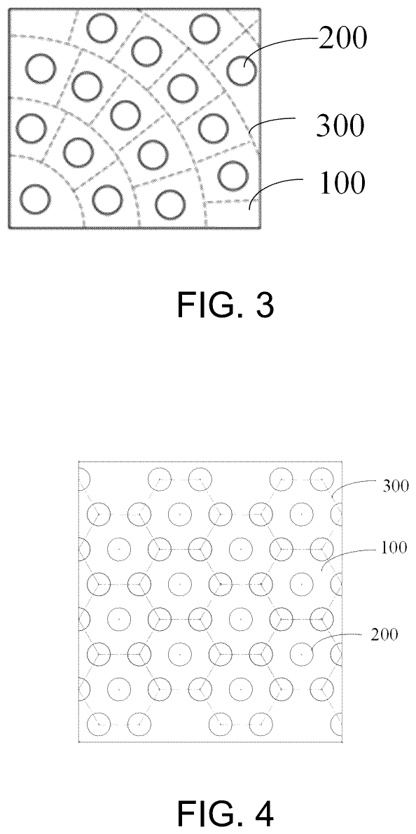

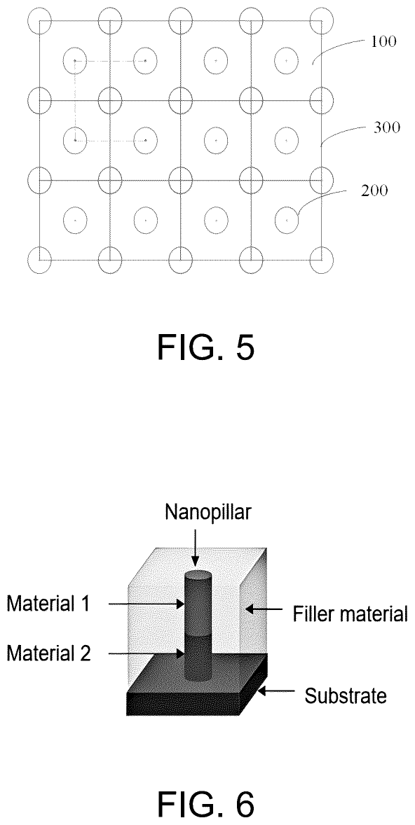

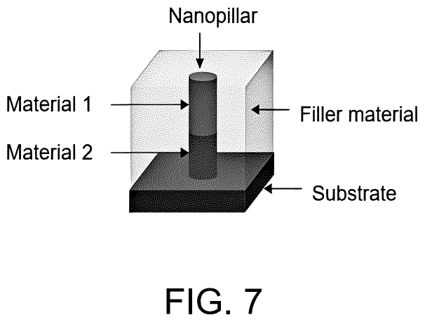

In an optional embodiment of the present application, as shown in FIG. 3 to FIG. 5, the plurality of nanostructures are arranged in a plurality of unit cells, and the plurality of nanostructures are in dense-packed patterns to form the unit cells, and the vertice or center of the dense-packed pattern is set with the nanostructure. Preferably, the shape of the unit cells 300 includes one or more shapes of a regular triangle, a square, a hexagon or a fan.

In one embodiment, as shown in FIG. 6, the nanostructures 200 may be a polarization-dependent structure, those structures apply a Pancharatnam-Berry phase to the incident light. In addition, the nanostructures 200 may be a polarization-independent structure, and those structures apply a propagation phase to the incident light.

In some embodiments, the athermal metalens provided by the embodiment of the present application also includes filler material, and the filler material is used to fill the gaps between the nanostructures. The filler materials include air or other materials with high transmittance in the working waveband. Optionally, the extinction coefficient of the filler material is less than 10⁻². Preferably, the absolute value of the difference between the refractive index of the filler material and the effective refractive index of the nanostructure 200 is greater than 0.5.

Therefore, the athermal metalens provided by the embodiment of the present application modulates the thermal refractive index coefficient by the nanostructures and thus makes the effective refractive index of the nanostructure insensitive to the temperature changes, which improves the deterioration of the metalens imaging performance caused by temperature drift.

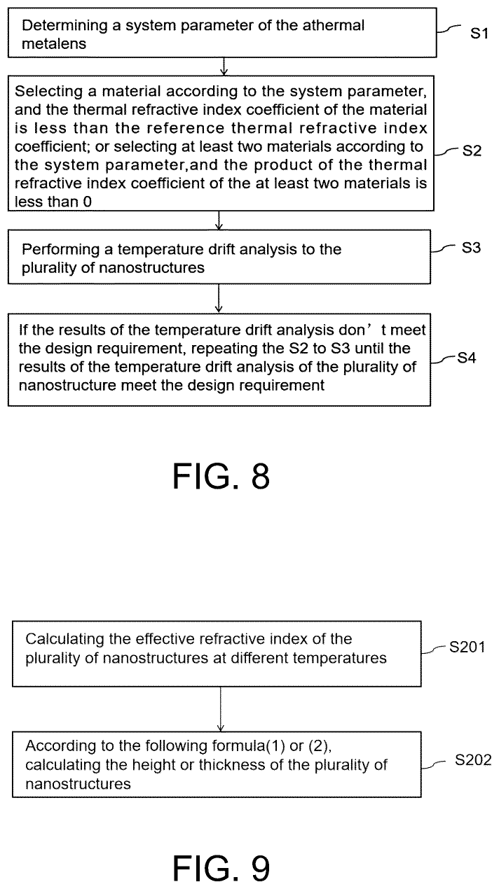

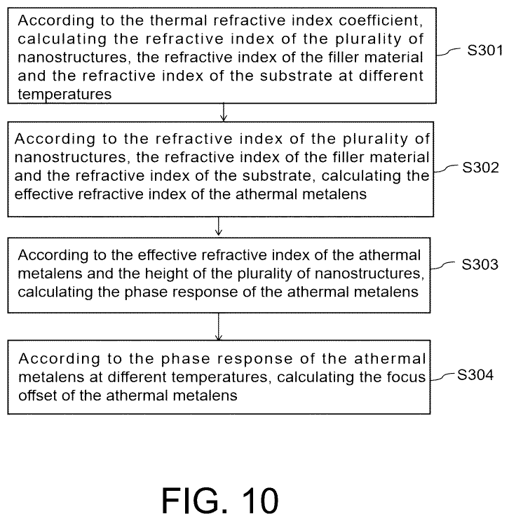

On the other hand, as shown in FIG. 8, the embodiment of this application also provides a design method for the athermal metalens. The method includes:
S1. determining a system parameter of the athermal metalens. And the system parameters include: the working temperature threshold (lower-temperature threshold and higher-temperature threshold), working waveband, field of view, focal length and aperture, etc.
S2. selecting a material according to the system parameter, and the thermal refractive index coefficient of the material is less than the reference thermal refractive index coefficient; or selecting at least two materials according to the system parameter, and the product of the thermal refractive index coefficient of the at least two materials is less than 0.
S3. performing a temperature drift analysis to the nanostructures 200.
S4. if the results of the temperature drift analysis don't meet the design requirement, repeating the S2 to S3 until the results of the temperature drift analysis of the nanostructure 200 meet the design requirement.
In the present application, as shown in FIG. 9, in S2, “selecting at least two materials according to the system parameter, and the product of the thermal refractive index coefficient of the at least two materials is less than 0” includes:
S201. calculating the effective refractive index of the plurality of nanostructures at different temperatures.
S202. according to the following formulas, calculating the height or thickness of the plurality of nanostructures;

$$\{ \begin{matrix}{h}_{1} \frac{{dn}_{1}}{dT} + {h}_{2} \frac{{dn}_{2}}{dT} + … + {h}_{i} \frac{{dn}_{i}}{dT} = 0 \\ H = \sum {h}_{i}\end{matrix} ; or$$

$$\{ \begin{matrix}{d}_{1} \frac{{dn}_{1}}{dT} + {d}_{2} \frac{{dn}_{2}}{dT} + … + {d}_{i} \frac{{dn}_{i}}{dT} = 0 \\ D = \sum {d}_{i}\end{matrix} ;$$

Where dnᵢ/dT is the thermal refractive index coefficient of each material in the nanostructure, hi is the height of each material in the nanostructure; H is the height of the nanostructure; di is thickness of each material along the direction perpendicular to the height axis; D is the total thickness of each material in the nanostructure.

In the present application, S3 includes:
S301. according to the thermal refractive index coefficient, calculating the refractive index of the plurality of nanostructures, the refractive index of the filler material and the refractive index of the substrate at different temperatures;
S302. according to the refractive index of the plurality of nanostructures, the refractive index of the filler material and the refractive index of the substrate, calculating the effective refractive index of the athermal metalens;
S303. according to the effective refractive index of the athermal metalens and the height of the plurality of nanostructures, calculating the phase response of the athermal metalens;
S304. according to the phase response of the athermal metalens at different temperatures, calculating the focus offset of the athermal metalens.

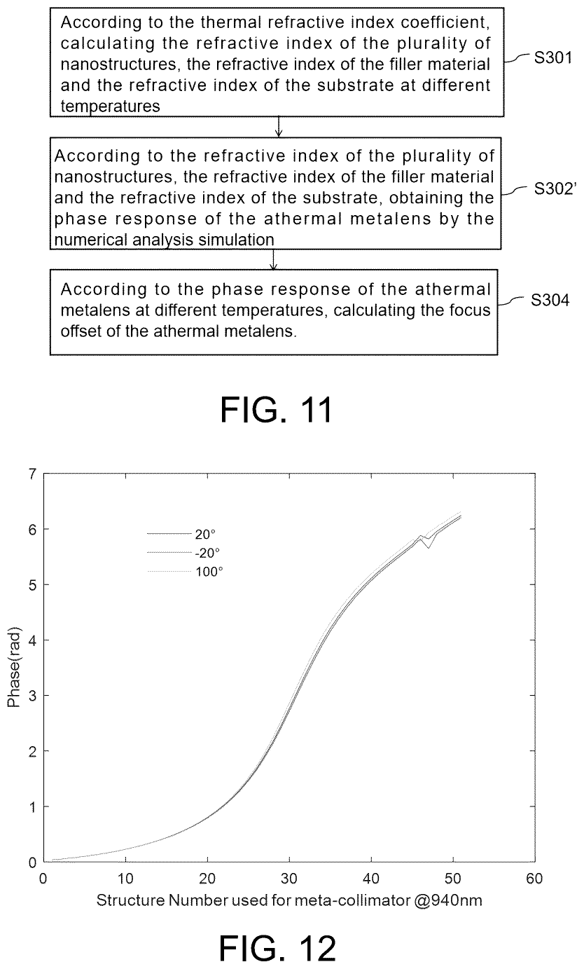

In some optional embodiments, as shown in FIG. 11, S3 includes:
S301. according to the thermal refractive index coefficient, calculating the refractive index of the plurality of nanostructures, the refractive index of the filler material and the refractive index of the substrate at different temperatures;
S302′. according to the refractive index of the nanostructures, the refractive index of the filler material and the refractive index of the substrate, obtaining the phase response of the athermal metalens by the numerical analysis simulation;
S304. according to the phase response of the athermal metalens at different temperatures, calculating the focus offset of the athermal metalens.

In the above temperature drift analysis method, the analysis speed of theoretical model is faster, while the speed of numerical simulation analysis is slower than the theoretical model, but the accuracy of the numerical simulation analysis is higher.

### Embodiment 1

In one embodiment, the athermal metalens is provided by the present application, which includes the quartz substrate and the amorphous silicon nanostructures set on the substrate. The aperture of the athermal metalens is 1 mm, and the focal length of the athermal metalens is 2.5 mm, and the athermal metalens is at the near-fared waveband of 940 mm. The material of the nanostructure is amorphous silicon, and the height of the nanostructure is 500 nm, and it is arranged as the positive hexagon in the unit cells. The periodicity of the positive hexagons is 450 nm, and the nanostructures are located at the vertice of the positive hexagon. The lower-temperature threshold of the athermal metalens is −20° C. and the higher-temperature threshold of the athermal metalens is 100° C.

The temperature drift of the athermal metalens at the wavelength of 940 nm is analyzed as following.

When the working wavelength is 940 nm, the thermal refractive index coefficient of the amorphous silicon is 3×10⁻⁴/K. Therefore, the refractive index of the nanostructures at −20° C. and 100° C. is 3.4927 and 3.5287, respectively. With a standard temperature of 20° C., the phase difference of the athermal metalens at −20° C. and 100° C. is 1.83º and 3.66°, respectively. By the numerical simulation model, the phase difference of the athermal metalens at −20° C. and 100° C. are 2.76° and 1.54°, respectively, refer to FIG. 12. FIG. 12 shows the phase response of different numbered nanostructures in the athermal metalens at different temperatures. According to FIG. 12, the focus drift of the athermal metalens between the lowest temperature and the highest temperature is less than or equal to 387 nm, and the maximum focus offset is less than 500 nm. Therefore, the athermal metalens provided in Embodiment 1 is insensitive to the temperature.

### Embodiment 2

In one embodiment, the athermal metalens is provided by the present application, which includes the quartz substrate and nanostructures set on the substrate. The aperture of the athermal metalens is 1 mm, and the focal length of the athermal metalens is 2.5 mm, and the athermal metalens is working at the near-fared waveband of 940 mm. The materials of the nanostructures along the direction away from the substrate are sapphire and barium fluoride (as shown in Table 1 for parameters).

According to the calculation of formula (1), in the nanostructures the height of barium fluoride is 715 nm, and the height of sapphire is 785 nm. In Embodiment 2, the nanostructures are arranged with positive hexagons in unit cells. The periodicity is 550 nm and the nanostructures are located at the vertice of the positive hexagon. A lower-temperature threshold of the athermal metalens is −20° C., and a higher-temperature threshold of the athermal metalens is 100° C.

The temperature drift of the athermal metalens at the wavelength of 940 nm is analyzed as following.

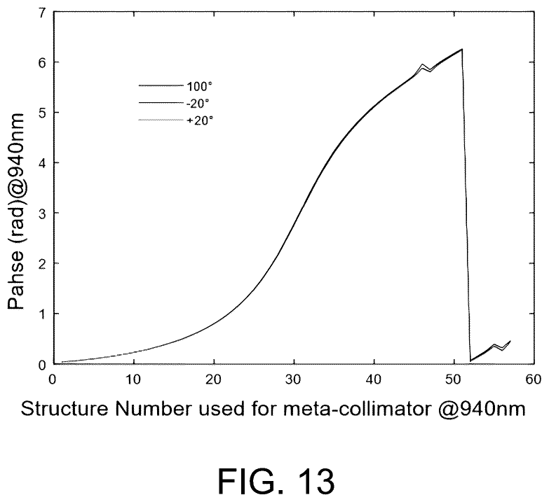

When the working wavelength is 940 nm, the thermal refractive index coefficient of the amorphous silicon is 3×10⁻⁴/K. As shown in Table 1, the barium fluoride nanostructures have a refractive index of 1.479 at 940 nm. The sapphire nanostructures have a refractive index of 1.757 at the 940 nm. The Table 1 also shows that the thermal refractive index coefficient of barium fluoride is −15/K, and the thermal refractive index coefficient of sapphire is −13.7/K. With a standard temperature of 20° C., FIG. 13 shows the phase response of different numbered nanostructures in the athermal metalens at different temperatures. As shown in FIG. 13, the maximum phase difference of all the nanostructures in Embodiment 2 at different temperatures is only 0.6°. According to FIG. 13, the focus drift between the lowest temperature and the highest temperature is less than or equal to 56 nm, and the maximum focus offset is much less than 500 nm. Therefore, the athermal metalens provided in Embodiment 2 is insensitive to the temperature.

TABLE 1
Parameters for the barium fluoride and the sapphire

| | Barium fluoride | Sapphire |
|---|---|---|
| Refractive index @940 nm | 1.479 | 1.757 |
| Thermal refractive index | −15 | −13.7 |
| coefficient (/K) | | |

In conclusion, the athermal metalens and design method provided in the embodiment of the present application modulate the thermal refractive index coefficient of the nanostructures. Thus, the effective refractive index of the nanostructures is insensitive to the temperature changes, and the deterioration of imaging performance caused by temperature drift of the metalens is improved.

The above is only a specific embodiment of the embodiment of this application, but the scope of protection of the embodiment of this disclosure is not limited to this, any person familiar with the scope of the change or substitution, should be covered within the protection scope of the embodiment of this application. Therefore, the scope of the protection of the present disclosure shall depend to the scope of the claims.

What is claimed is:

1. An athermal metalens, wherein the metalens comprises:
a substrate and a plurality of nanostructures;
the plurality of nanostructures are set on at least one side of the substrate, and are arranged in a periodicity;
wherein, a thermal refractive index coefficient of the plurality of nanostructures is less than a reference thermal refractive index coefficient.

2. The athermal metalens of claim 1, wherein the metalens comprises:
the reference thermal refractive index coefficient is greater than or equal to 0.01×10⁻⁶/K, and is less than or equal to 3000×10⁻⁶/K.

3. The athermal metalens of claim 1, wherein the metalens comprises:
a filler material, and the filler material is used to fill the gaps between the plurality of nanostructures.

4. The athermal metalens of claim 1, wherein the metalens comprises:
the plurality of nanostructures are arranged in a plurality of unit cells,
the plurality of nanostructures are in dense-packed patterns to form the unit cells, and the vertice or center of the dense-packed pattern is set with the nanostructure.

5. The athermal metalens of claim 1, wherein the extinction coefficient of the plurality of nanostructures is less than 10⁻².

6. The athermal metalens of claim 1, wherein the extinction coefficient of the substrate is less than 10⁻⁴.

7. An athermal metalens, wherein the metalens comprises:
a substrate and a plurality of nanostructures;
the plurality of nanostructures are set on one side of the substrate at least and arranged in periodicity;
wherein each nanostructure is composed of at least two materials, and the product of the thermal refractive index coefficient of the at least two materials is less than 0.

8. The athermal metalens of claim 7, wherein the metalens comprises:
the reference thermal refractive index coefficient is greater than or equal to 0.01×10⁻⁶/K, and is less than or equal to 3000×10⁻⁶/K.

9. The athermal metalens of claim 7, wherein when the nanostructure is composed of at least two materials, the nanostructure is made of two different materials along the direction of the height axis.

10. The athermal metalens of claim 7, wherein when the nanostructure is composed of at least two materials, the nanostructure is made of two different materials along the direction perpendicular to the height axis.

11. The athermal metalens of claim 7, wherein the metalens comprises:
the plurality of nanostructures are arranged in a plurality of unit cells,
the plurality of nanostructures are dense-packed pattern to form the unit cell, and the vertice or center of the dense-packed pattern is set with the nanostructure.

12. The athermal metalens of claim 7, wherein the extinction coefficient of the nanostructure is less than 10⁻².

13. The athermal metalens of claim 7, wherein the metalens comprises:
a filler material, and the filler material is used to fill the gaps between the nanostructures.

14. A design method for an athermal metalens, the design method is applied to the athermal metalens of claim 1, wherein the method comprises:
S1: determining a system parameter of the athermal metalens;
S2: selecting a material according to the system parameter, and the thermal refractive index coefficient of the material is less than the reference thermal refractive index coefficient;
S3: performing a temperature drift analysis to the plurality of nanostructures;
S4: if the results of the temperature drift analysis don't meet the design requirement, repeating the S2 to S3 until the results of the temperature drift analysis of the plurality of nanostructure meet the design requirement.

15. The design method for an athermal metalens of claim 14, wherein the S3 comprises:
S301: according to the thermal refractive index coefficient, calculating the refractive index of the plurality of nanostructures, the refractive index of the filler material and the refractive index of the substrate at different temperatures;
S302: according to the refractive index of the plurality of nanostructures, the refractive index of the filler material and the refractive index of the substrate, calculating the effective refractive index of the athermal metalens;
S303: according to the effective refractive index of the athermal metalens and the height of the plurality of nanostructures, calculating the phase response of the athermal metalens;
S304: according to the phase response of the athermal metalens at different temperatures, calculating the focus offset of the athermal metalens.

16. The design method for an athermal metalens of claim 14, wherein the S3 comprises:
S301: according to the thermal refractive index coefficient, calculating the refractive index of the plurality of nanostructures, the refractive index of the filler material and the refractive index of the substrate at different temperatures;
S302′: according to the refractive index of the nanostructures, the refractive index of the filler material and the refractive index of the substrate, obtaining the phase response of the athermal metalens by the numerical analysis simulation;
S304: according to the phase response of the athermal metalens at different temperatures, calculating the focus offset of the athermal metalens.

17. A design method for an athermal metalens, the design method is applied to the athermal metalens of claim 7, wherein the method comprises:
S1: determining a system parameter of the athermal metalens;
S2: selecting at least two materials according to the system parameter, and the product of the thermal refractive index coefficient of the at least two materials is less than 0;
S3: performing a temperature drift analysis to the plurality of nanostructures;
S4: if the results of the temperature drift analysis don't meet the design requirement, repeating the S2 to S3 until the results of the temperature drift analysis of the plurality of nanostructure meet the design requirement.

18. The design method for an athermal metalens of claim 17, wherein the S2 comprises:
S201: calculating the effective refractive index of the plurality of nanostructures at different temperatures;
S202: according to the following formulas, calculating the height or thickness of the plurality of nanostructures;
$$\{ \begin{matrix}{h}_{1} \frac{{dn}_{1}}{dT} + {h}_{2} \frac{{dn}_{2}}{dT} + … + {h}_{i} \frac{{dn}_{i}}{dT} = 0 \\ H = \sum {h}_{i}\end{matrix} ; or$$
$$\{ \begin{matrix}{d}_{1} \frac{{dn}_{1}}{dT} + {d}_{2} \frac{{dn}_{2}}{dT} + … + {d}_{i} \frac{{dn}_{i}}{dT} = 0 \\ D = \sum {d}_{i}\end{matrix} ;$$
Wherein, dnᵢ/dT is the thermal refractive index coefficient of each material in the nanostructure, hᵢ is the height of each material in the nanostructure; H is the height of the nanostructure; dᵢ is thickness of each material along the direction perpendicular to the height axis; D is the total thickness of each material in the nanostructure.

19. The design method for an athermal metalens of claim 17, wherein the S3 comprises:
S301: according to the thermal refractive index coefficient, calculating the refractive index of the plurality of nanostructures, the refractive index of the filler material and the refractive index of the substrate at different temperatures;
S302: according to the refractive index of the plurality of nanostructures, the refractive index of the filler material and the refractive index of the substrate, calculating the effective refractive index of the athermal metalens;
S303: according to the effective refractive index of the athermal metalens and the height of the plurality of nanostructures, calculating the phase response of the athermal metalens;
S304: according to the phase response of the athermal metalens at different temperatures, calculating the focus offset of the athermal metalens.

20. The design method for an athermal metalens of claim 17, wherein the S3 comprises:
S301: according to the thermal refractive index coefficient, calculating the refractive index of the plurality of nanostructures, the refractive index of the filler material and the refractive index of the substrate at different temperatures;
S302′: according to the refractive index of the plurality of nanostructures, the refractive index of the filler material and the refractive index of the substrate, obtaining the phase response of the athermal metalens by the numerical analysis simulation;
S304: according to the phase response of the athermal metalens at different temperatures, calculating the focus offset of the athermal metalens.
